(19) United States
(12) Patent Application Publication
(10) Pub. No.: US 2022/0026876 A1
(43) Pub. Date: Jan. 27, 2022

(54) GEOMETRICAL COMPENSATIONS

(71) Applicant: HEWLETT-PACKARD DEVELOPMENT COMPANY, L.P., Spring, TX (US)

(72) Inventors: Sergio Gonzalez Martin, Sant Cugat del Valles (ES); Enrique Gurdiel Gonzalez, Sant Cugat del Valles (ES); Manuel Freire Garcia, Sant Cugat del Valles (ES); Jordi Sanroma Garrit, Sant Cugat del Valles (ES)

(73) Assignee: HEWLETT-PACKARD DEVELOPMENT COMPANY, L.P., Spring, TX (US)

(21) Appl. No.: 17/296,901

(22) PCT Filed: Apr. 30, 2019
(86) PCT No.: PCT/US2019/029824

§ 371 Date: May 25, 2021

(51) Int. Cl. G05B 19/4099; G05B 19/404; B29C 64/386; B33Y 50/00

(52) U.S. Cl. CPC G05B 19/4099; G05B 19/404; G05B 2219/35134; B33Y 50/00; B29C 64/386

(57) ABSTRACT

In an example, a machine-readable medium stores instructions which, when executed by a processor, cause the processor to: update a 3D printing geometrical compensation model with at least one correction determined using a combination of a dimensional correction determined from measurements of objects generated using a first geometrical compensation and a dimensional correction determined from measurements of objects generated using a modified version of the first geometrical compensation.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is an example method for modifying geometrical compensations;

FIG. 2 is an example method for determining a compensation correction;

FIG. 3 is an example of a method of object generation;

FIGS. 4 and 5 show simplified schematic drawings of example apparatus comprising processing circuitry; and

FIG. 6 is a simplified schematic drawing of an example machine-readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved using heat, for example through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material heats up, coalesces and solidifies upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. In examples, such a fusing agent may comprise any or any combination of an infra-red light absorber, a near infra-red light absorber, a visible light absorber and a UV light absorber. Examples of print agents comprising visible light enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed, and may for example act to cool the build material to which it is applied (or otherwise prevent or reduce coalescence thereof). According to one example, a suitable detailing agent may be a formulation commercially referred to as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to derive slices of parallel planes of the model. Each slice may define a portion of a respective layer of build material that is to be solidified or caused to coalesce by the additive manufacturing system.

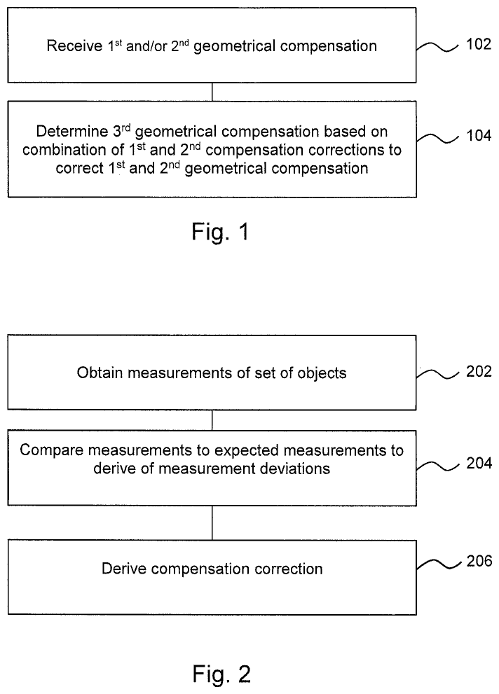

FIG. 1 is an example of a method, which may comprise a computer implemented method which may be used to determine a modified or updated geometrical compensation for use in additive manufacturing.

Block 102 comprises receiving, at a processor, at least one of a first and a second geometrical compensation, wherein the first and/or second geometrical compensation are to compensate for anticipated deformations in additive manufacturing. In particular, the geometrical compensations may describe geometrical transformation(s) which may be used to modify object model data, for example to apply a geometrical compensation in order to compensate for anticipated departures from intended dimensions when generating an object. The geometrical compensation(s) may, for example, be received over a network or communications link, or may be received from a memory or the like. The geometrical compensation(s) may for example comprise one or more geometrical compensation parameters, and may comprise geometrical compensation models.

For example, it may be the case that when an object is generated in a process which includes heat, additional build material may adhere to the object on generation. In one example, fusing agent may be associated with a region of the layer which is intended to fuse. However, when energy is supplied, build material of neighbouring regions may become heated and fuse to the outside of the object (in some examples, being fully or partially melted, or adhering to melted build material as powder). Therefore, a dimension of an object may be larger than the region(s) to which fusing agent is applied. In order to compensate for this effect, i.e. where it is anticipated that an object may tend to ‘grow’ during manufacture in this manner, the object volume as described in object model data may be reduced to compensate for such growth. The reduction of the volume may be defined in a geometrical compensation (or geometrical transformation) model as at least one geometrical compensation parameter value.

In other examples, objects may be smaller following object generation than is specified in object model data. For example, some build materials used to generate objects may shrink on cooling. Therefore, a geometrical compensation/transformation may specify at least one geometrical compensation parameter to in turn specify how an object volume representation in object model data should be increased to compensate for the anticipated reduction in volume.

A particular object may be subject to mechanisms which result in growth and/or shrinkage, and the actual compensation to be applied may be determined by consideration of, or may be influenced by, the different degrees to which an object may be affected by such processes.

In some examples, a modification may be specified using geometrical compensation parameter(s) comprising scaling and/or offset parameter(s) (for example, a scaling factor and/or an offset value). A scaling factor may be used to multiply all specified dimensions in the direction of at least one axis by a value, and may be greater than 1 in order to increase the dimension(s) and less than 1 to reduce the dimension(s). An offset value may specify, for example by a specified distance or a number of defined sub volumes or ‘voxels’ (i.e. three-dimensional pixels), an amount to add or remove from a surface of the object (or a perimeter within a layer). For example, a distance as measured in the direction of a normal from the object surface may be specified and the object may be eroded or dilated (i.e., inflated or enlarged) by this distance.

In the examples set out herein, it is assumed that there is at least one predetermined geometrical compensation (which may be, or may be derived from, a geometrical compensation model specifying geometrical compensation parameter(s)) which has been selected for use. This may for example comprise the first geometrical compensation (on which the second geometrical compensation may be based).

Geometrical compensations may in some examples be determined based on a theoretical analysis of object generation, for example considering the predicted temperatures and/or material behaviour characteristics. In other examples, or in addition, such geometrical compensations may for example be determined by trial and error over time. For example, geometrical compensations may be determined based on test objects, which may be generated and measured to characterise the deformations. In some examples, geometrical compensations may be derived using data fitting techniques (such as regression models) and/or using machine learning techniques based on deviations from expected dimensions in previously generated objects or the like.

One example of a geometrical compensation may comprise one or a set of scaling and/or offset parameters associated with a particular object generation apparatus, or type of object generation apparatus. The parameters may be applied to all objects in the same way (for example, regardless of the object size and/or placement).

In some examples, a geometrical compensation model may allow a geometrical compensation derived or selected therefrom to be tailored to an intended object generation operation and/or object.

For example, a geometrical compensation model may be derived which takes account of an intended location of an object in a fabrication chamber. It has been noted that dimensional deformation is related to the location of object generation when determining a compensation, and therefore different compensation parameter values may be applied for different object locations to improve accuracy. Such geometrical compensation models may therefore comprise or provide compensation parameters which may be mapped to the intended location of an object (which may for example be a single identifiable point such as the location of the centre of mass of the object, or may include a consideration of the volumetric extent of the object).

For example, if an object is to be generated at a first location within the fabrication chamber, the location may be mapped to a geometrical compensation comprising one or more offset and/or scaling parameter value(s). However, if the same object were to be generated at a second location within the fabrication chamber, this second location may be mapped to a different geometrical compensation comprising one or more different offset and/or scaling parameter value. Thus, the particular geometrical compensation applied may vary between different locations based on predetermined mappings or the like.

In some examples, at least one geometrical compensation model may be derived which comprises a plurality of defined geometrical compensation parameters (or parameter sets), each associated with different locations within the fabrication chamber. In some examples, defined locations may be associated with geometrical compensation parameter(s), and the geometrical compensation parameter(s) to apply at locations intermediate to such defined locations may be derived for example by interpolation, or by selection of the closest defined location, or the like.

As briefly mentioned above, in some examples, geometrical compensations may comprise at least one geometrical modification parameter, and may in some examples be defined using two or three scaling factors (one for each of two/three axes, which may be orthogonal) and/or two or three offset values (one for each of two/three axes, which may be orthogonal). If scaling is not indicated in a given axis, the scaling factor in relation to that axis may be set to 1, and if no offset is indicated in a given axis, the offset value in relation to that axis may be set to 0. In some examples, a geometrical compensation parameter may be determined, selected or derived from a geometrical compensation model. This may be used to modify object model data, for example providing an object model which is enlarged or reduced in at least one dimension. For example, a geometrical compensation parameter may be specified as scaling and/or offset components in an X and Y axis (for example to be applied in a single slice of an object), or as scaling and/or offset components in an X, Y and Z axis.

Taking an example in which a scaling factor is specified in each of three orthogonal axes, this may in some examples be specified as a vector having components in the X, Y and Z directions, and may for example be specified as [SFx, SFy, SFz]. This may, for example, taking the object in its intended generation orientation, mean that the ‘width’ of the object is to be scaled by SFx, the ‘depth’ of the object is to be scaled by SFy, and the ‘height’ of the object is to be scaled by SFz (noting that, in practice, the object may be generated in any orientation, and therefore the height of the object during generation may not correspond to the height of the object as oriented for use thereof following generation).

In some examples, characteristics of the object, such as consideration of the object volume and/or surface area, may be used as input parameters in a geometrical compensation model. For example, bulkier objects may accrue greater thermal energy than smaller objects, and may therefore tend to accumulate more heat than smaller objects. Cooling such objects may therefore take more time than cooling less bulky objects. This may lead to different deformations. Thus, in one example a first compensation model may comprise a compensation factor associated with object volume while in other examples there may be no such compensation factor, or a different compensation factor may be used. The surface area (and combinations of the volume and surface area) may be used to determine how ‘solid’ an object is. The amount of solid material in an object may be used to predict how the object may deform. For example, a more solid object may tend to accumulate more heat than a less solid object in a thermal fusing additive manufacturing operation. Such object generation parameters may therefore be mapped to different geometrical compensation parameter values within a geometrical compensation model.

Some geometrical compensation models may for example include a consideration of how many objects are to be generated in a fabrication chamber and/or the proximity of the objects (for example in terms of ‘packing density’).

In some examples, other object generation parameter values (which may be object generation parameter values which are configurable or selectable by a user or operator) may be considered. The object generation parameter(s) may be any object generation parameter which may have an impact on dimensional inaccuracy. For example, the parameter(s) may comprise any, or any combination of, environmental conditions, object generation apparatus, object generation material composition (which may comprise selection of the type or composition of build material and/or print agents), object cooling profile or print mode, or the like. These may be specified, for example, by input to at least one processor. Thus different geometrical compensations may be provided for different apparatus, different print modes, different cooling profiles and the like.

The geometrical compensations and/or geometrical compensation model(s) specifying compensation parameters may for example be stored in a memory, for example embodied as mapping resource(s) such as lookup tables and the like, or may be embodied as at least one algorithm, for example relating object parameter(s), and/or generation parameter(s) (e.g. any or any combination of object generation location, volume, surface area, packing density, environmental conditions, object generation apparatus, object generation material composition, object cooling profile or print mode as outlined above) to at least one compensation parameter to be applied to object model data.

Objects to be generated by additive manufacturing apparatus may be described using object model data. The object model data may comprise data representing at least a portion (in some examples, a slice) of an object to be generated by an additive manufacturing apparatus by fusing a build material. The object model data may for example comprise a Computer Aided Design (CAD) model, and/or may for example be a STereoLithographic (STL) data file. In some examples, the object model data may represent an object or object portion as a plurality of sub-volumes, wherein each sub-volume represents a region of the object which is individually addressable in object generation. In some examples herein, the sub-volumes may be referred to as voxels, i.e. three-dimensional pixels. In some examples, the object model data may represent a printable arrangement of a plurality of objects to be generated by an additive manufacturing apparatus by fusing build material within a fabrication chamber.

Block 104 comprises determining a third geometrical compensation based on a combination of a first compensation correction for a first build operation which utilised the first geometrical compensation to modify object data used for generation of a first set of objects, and a second compensation correction for a second build operation which utilised the second geometrical compensation to modify object data used for generation of a second set of objects. As will be set out in greater detail below, the first compensation correction is a correction which was derived to correct for deviations between the dimensions of the first set of objects and their intended dimensions and the second compensation correction is a correction which was derived to correct for deviations between the dimensions of the second set of objects and their intended dimensions. In other words, the first compensation correction is to correct for deficiencies in the performance of the first compensation and the second compensation correction is to correct for deficiencies in the performance of the second compensation. Such deficiencies may for example result from parameter ‘drift’ in an additive manufacturing apparatus or environment which may occur over time, or may be seen over a series of iterative improvements of a geometrical compensation. As is also set out below, the combination may be a difference. However, the difference may not be a strict numerical difference (e.g. a subtraction of one value from another), but may be an overall difference in the effect, and may include the effect of a difference. For example, this may include the effect of a difference in scale (which may operate multiplicatively rather than additively) and/or in offset. Therefore, the difference represents an evolution or increment to the correction applied, and may be determined by combining the first and second compensation corrections.

In this example, the first and second geometrical compensations are related, with the second geometrical compensation being a modified version of the first geometrical compensation. The second geometrical compensation may be a first generation modification of the first geometrical compensation, or a later generation modified version, as is set out in greater detail below.

In some examples, the values may be a ‘per-object’ value, whereas in other examples, the values may be averages over multiple objects.

In examples herein, the first and second geometrical compensations are used to modify object model data which is in turn used to generate, respectively a first and second set of objects. The compensation corrections are obtained from measurements of the first and second set of objects.

FIG. 2 is an example of a method, which may be a computer implemented method, for deriving a compensation correction from the measurements.

Block 202 comprises obtaining a plurality of measurements of a set of objects (for example, the first set of objects or the second set of objects).

Obtaining the measurements may comprise receiving, by a processor, the measurements from a memory and/or over a communication link. In some examples, obtaining the measurements may comprise measuring the objects. For example, such measuring may be carried out using at least one of 3D scanning, other optical measurement techniques and manual measurements. The measurements may be acquired automatically in some examples. In some examples, a plurality of measurements are acquired from at least one of the objects, and in some examples from each of a set of objects.

Block 204 comprises comparing the measurements to expected measurements to derive a set of indications of measurement deviations.

For example, there may be a set of measurements acquired in directions which, in the orientation in which the objects were generated, were parallel to the X axis. The measurements below relate to three different example objects, each of which is associated with three different measurements:

| | Measured | expected | Deviation |
|---|---|---|---|
| Object | (mm) | (mm) | (mm) |
| A | 102.2 | 100 | 2.2 |
| | 208.4 | 204 | 4.4 |
| | 156.3 | 153 | 3.3 |
| B | 102.4 | 100 | 2.4 |
| | 208.6 | 204 | 4.6 |
| | 156.1 | 153 | 3.1 |
| C | 101.9 | 100 | 1.9 |
| | 208.1 | 204 | 4.1 |
| | 156.0 | 153 | 3 |

While in this example, the deviations were positive, in other examples, deviations may be negative.

Block 206 comprises deriving a compensation correction based on the deviations. For example, a scale factor and offset may be determined for example based on a linear regression which determines ‘best fit’ scale and offset values for the relationship:

Measured dimension=expected dimension*scale+offset

This may in effect comprise determining a slope and an offset of a ‘best fit’ straight line.

In this example, this may for example provide, on a ‘per object’ basis:

| | Scale deformation | Offset |
|---|---|---|
| | correction | deformation |
| Object | (unitless) | correction (mm) |
| A | 1.02115 | 0.07796 |
| B | 1.0211 | 0.1521 |
| C | 1.021 | −0.222 |

In other examples, the correction may be determined in some other way, for example as an average of the deviations.

In some examples, a compensation correction may be applied to compensate for the shift in behaviour of the model. For example, the scale may be set to 1/(correction scale) and the offset may be the negative of the correction offset determined in the table. In examples herein, the compensation corrections are combined to determine a third compensation, as is further set out below.

In the event that there are insufficient measurements to reliably determine a linear regression, it may be assumed that the deformation is due to a scaling difference, with offsets being ignored.

In some examples, an average correction may be determined for the build operation as a whole, while in some examples, a ‘per object’ average may be used (e.g. the figures for scale and offset determined above may be used independently for a ‘per object’ correction, or may be averaged to determine a single scale and offset value).

In practice, there may be many more such measurements, for example numbering in the hundreds or even in the thousands.

To consider the methods of FIG. 1 and FIG. 2, a geometrical compensation may provide a compensation transformation of T. A transformation correction, for example derived using the method set out in FIG. 2 may be referred to as TC.

If a reference geometrical compensation is designated T₀, this may be used to generate a reference set of objects, from which a reference compensation correction is derived, which may be designated TC₀. In following object generation operations, changes to the compensation correction can be monitored to adjust the geometrical compensations of further repetitions. If a first set of objects is obtained using the reference geometrical compensation, T₁=T₀, from which a compensation correction TC₁ is derived, this may be used to provide a modified version of the geometrical compensation, which will be designated T₂, based on a combination of TC₁ and TC₀ which describes the difference (i.e. the difference in effect, or the increment) therebetween.

Then, this T₂ may be used to modify object data in order to generate a second set of objects, from which a second compensation correction is derived: TC₂. Then, according to the method of FIG. 1, a third compensation T₃ may be determined based on the increment between TC₀ and TC₂ and so on. Thus T₃ may be viewed as a first generation modification of T₂, or a second generation modification of T₁.

Modelling the operation using a composition operation (O) and a delta operation (Δ), this may be expressed as:

Tₙ₊₁=T₀O(TCₙΔTC₀) (Eqn A)

Where the delta operation models the increment or difference in the correction between Tₙ and T₀. To consider the nature of the offset and the scale factor separately, these may be modelled as:

Offset: Tₙ₊₁=T₀+(TCₙ−TC₀) (Eqn B)

Scale: Tₙ₊₁=T₀*(TCₙ/TC₀) (Eqn C)

Where TCₙ is the transformation that corrects the calibration parts included in the nth build operation (e.g. the transformations(s) determined using the averages set out above). It may be noted that if a geometrical compensation functions as intended, TCₙ would have values of 0 for offset or 1 for scale for that iteration.

The effect of this transformation is to apply the increment of the compensation which would have applied to the original calibration print to a subsequent print operation.

For completeness, it may be noted that Eqn B is equivalent to Tₙ₊₁=Tₙ+(TCₙ−TCₙ₋₁)

To demonstrate, as (in a previous iteration) Tₙ=T₀+(TCₙ₋₁−TC₀) then rearranging the terms give:

T₀=Tₙ−(TCₙ₋₁−TC₀) (Eqn C).

Substituting for T₀ in eqn B with eqn C gives:

Tₙ₊₁=Tₙ−(TCₙ₋₁−TC₀)+(TCₙ−TC₀)=Tₙ+(TCₙ−TCₙ₋₁), and therefore:

Tₙ₊₁=Tₙ+(TCₙ−TCₙ₋₁); and

Tₙ₊₁=T₀+(TCₙ−TC₀)

An equivalent analysis may be applied to Eqn C:

Tₙ=T₀*(TCₙ₋₁/TC₀)

T₀=Tₙ/(TCₙ₋₁/TC₀)

Tₙ₊₁=Tn/(TCₙ₋₁/TC₀)*(TCₙ/TC₀)=Tn*(TCₙ/TCₙ₋₁)

Thus the method may be carried out by modifying either of a last-used geometrical compensation Tₙ with combination of the associated correction TCₙ and the correction applied for the iteration previous to that last-used geometrical compensation TCₙ₋₁, or an older compensation T₀, based on the combination of a correction associated with a last-used compensation TCₙ and the correction associated with the older compensation TC₀. Thus, if the second compensation is a modified version of the first compensation, it may be the second compensation Tₙ which is modified to determine the third compensation Tₙ₊₁ (where Tₙ₋₁ is the first compensation in such an example), or it may be the first compensation T₀ which is modified to determine the third compensation Tₙ₊₁ (where Tₙ is the second compensation in such an example).

It may be noted that T may take different values for, for example, different object generation locations, or different object volumes or the like.

The method may be iterated, with new objects being generated using the updated transformations described by Tₙ₊₁.

In this way, geometrical compensations which may perform well initially, but less well over time, may be adapted. For example, a particular apparatus may be associated with, or may develop, a shift: a particular axis may be associated with a deformation which is fairly consistently under or over compensated for in a generic model. Such a shift may be taken into account by deriving a correction to geometrical compensation parameter(s) and models. In other examples, an initially poorly performing model may be iteratively improved or calibrated to given apparatus/objects or the like.

In some examples, corrections to tailor or calibrate the geometrical compensation may be applied to a model as a whole (which may compensate well for ‘shifts’ in offsets and scales which have been noted between additive manufacturing apparatus). For example, at least one multiplicative factor or offset may be associated (for example for each parameter type and/or each axis) with an original geometrical compensation and therefore effectively derives a new geometrical compensation. In other words, different values of a compensation model (e.g. a location specific compensation model) may be modified by the same modification. In other examples, the modifications may be based on objects having the same parameters as the object modelled (e.g. the modification may be a location specific modification based on objects generated in particular locations, or at least in a particular zone of the fabrication chamber).

The first and second set of objects (and, where applicable, a third and any other set) may be based on the same underlying object model data, albeit modified using different parameters. In some examples, the first and second set of objects may be calibration objects included in a fabrication chamber which is also being used to generate other objects (e.g. ‘production objects’, which are for use for purposes other than calibrating/correcting the compensations to be applied). In some examples, the underlying object model data for all objects in the fabrication chamber may remain consistent for multiple build operations, so as to generate multiple batches of the production objects and the calibration objects. High levels of accuracy may be achieved using such repeated batches and iterative corrections as described herein, as the variables are relatively contained.

In some examples, the first and second set of objects (and, where applicable, a third and any other set) of objects are generated using the same additive manufacturing material(s) (in some examples, the same build material) and/or object generation parameters, apparatus or class of apparatus. A geometrical compensation and/or a correction thereto may be specific to any or any combination of an additive manufacturing material and/or to an object generation parameter, apparatus or class of apparatus used.

The objects of a set may be distributed throughout the fabrication chamber, for example to sample different regions of the fabrication chamber such that the determined correction represents the entire fabrication chamber.

By using corrected compensation parameters to modify object model data, an object once formed may end up being closer to an intended size.

In some examples, the methods set out herein may be combined with other methods of object model modification. For example, a modification function may be employed in the vicinity, or locality, of small features. An erosion of such small features may result in an unacceptable reduction in their size, either obliterating the feature or rendering it too small to fuse or too delicate to survive cleaning operations. For example, if a feature has a dimension of around 0.5 mm, this may correspond to 12 voxels at 600 dpi. If three or four voxels are eroded from the side of such a small feature, it will lose approximately 50 to 60% of its cross-section, reducing its size to less than 0.3 mm. Such a feature may be too small to survive cleaning operations. Thus, in some examples, other functions may be used to ensure that small features are preserved.

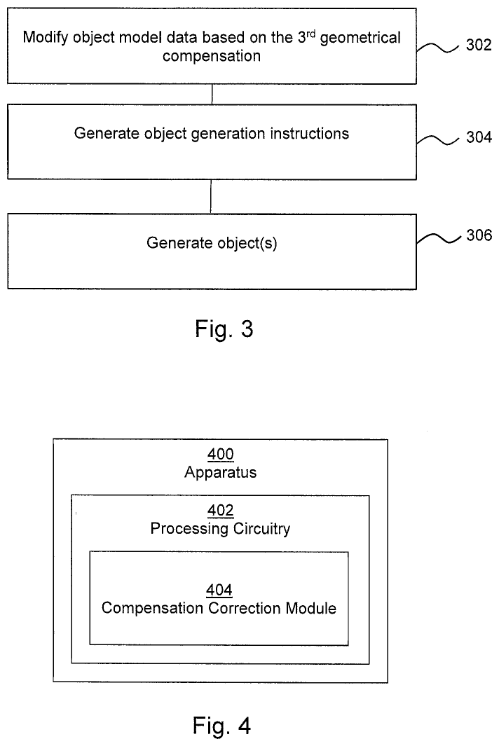

FIG. 3 is an example of a method which may be used to generate object(s), in this example based on the third geometrical compensation, although the methods described may also be used for previous or subsequent iterations of the method.

Block 302 comprises modifying object model data based on the third geometrical compensation (i.e. the third geometrical compensation derived using the method of FIG. 1). This may comprise operating on mesh, vector and/or voxel models of at least one object using the geometrical transformation(s) of the third geometrical compensation, which is intended to compensate for deformations in object generation operations. In some examples, the geometrical compensation may be selected on an object by object basis, for example based on the object location, or some other object parameter and/or object generation parameter. In some examples, the geometrical compensation applied may be selected based on at least one object generation parameter, such as the object generation apparatus or build material to be used.

Block 304 comprises determining object generation instructions (or ‘print instructions’) for generating object(s). The object generation instructions in some examples may specify an amount of print agent to be applied to each of a plurality of locations on a layer of build material. For example, determining object generation instructions may comprise determining ‘slices’ of a virtual build volume comprising virtual object(s) (to which a modification may have been applied), and rasterising these slices into pixels (or voxels, i.e. three-dimensional pixels). An amount of print agent (or no print agent) may be associated with each of the pixels/voxels. For example, if a pixel relates to a region of a build volume which is intended to solidify, the object generation instructions may be determined to specify that fusing agent should be applied to a corresponding region of build material in object generation. If however a pixel relates to a region of the build volume which is intended to remain unsolidified, then object generation instructions may be determined to specify that no agent, or a coalescence modifying agent such as a detailing agent, may be applied thereto, for example to cool the build material. In addition, the amounts of such agents may be specified in the determined instructions and these amounts may be determined based on, for example, thermal considerations and the like.

Block 306 comprises generating at least one object based on the object generation instructions. For example, an object may be generated layer by layer. For example, this may comprise forming a layer of build material, applying print agents, for example through use of ‘inkjet’ liquid distribution technologies in locations specified in the object generation instructions for an object model slice corresponding to that layer using at least one print agent applicator, and applying energy, for example heat, to the layer. Some techniques allow for accurate placement of print agent on a build material, for example by using print heads operated according to inkjet principles of two dimensional printing to apply print agents, which in some examples may be controlled to apply print agents with a resolution of around 600 dpi, or 1200 dpi. A further layer of build material may then be formed and the process repeated, for example with the object generation instructions for the next slice. In other examples, objects may be generated using directed energy, or through use of chemical binding or curing, or in some other way.

FIG. 4 shows apparatus 400 comprising processing circuitry 402, the processing circuitry 402 comprising a compensation correction module 404.

In use of the apparatus 400, the compensation correction module 404 updates (or calibrates) a geometrical compensation parameter with a correction parameter. The correction parameter may be determined using a combination of a dimensional correction determined from measurements of objects generated using a first geometrical compensation and a dimensional correction determined from measurements of objects generated using a modified version of the first geometrical compensation. The combination may indicate the difference between the effect of these compensations.

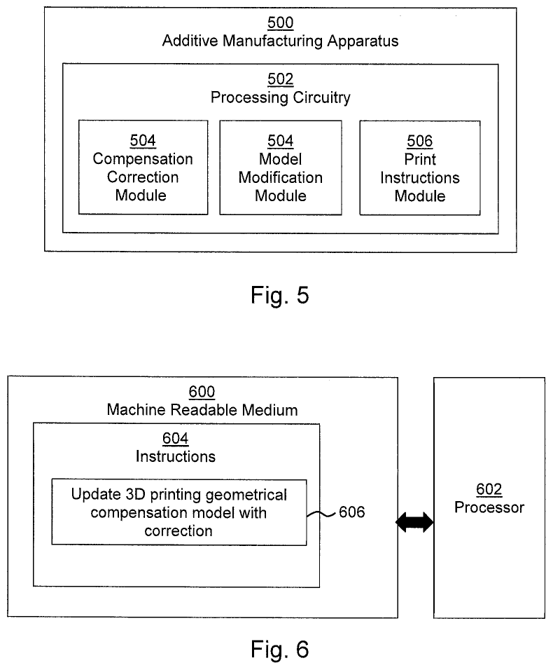

FIG. 5 shows additive manufacturing apparatus 500 comprising processing circuitry 502, the processing circuitry 502 comprising the compensation correction module 404 described above and further comprising a model modification module 504 and a print instructions module 506.

In use of the apparatus 500, the model modification module 504 modifies a virtual object representing a first object to be generated using additive manufacturing using the updated geometrical compensation derived by the compensation correction module 404. In some examples the apparatus 400, 500 may apply a geometric transformation for an object to be generated using additive manufacturing based on a geometrical compensation such as the first or second compensation (or the first and/or second compensation as modified by the compensation correction module 404) and may modify the object model data using the geometrical transformation described therein.

The print instructions module 506, in use of the additive manufacturing apparatus 500, determines print instructions for generating the object from data representing the modified virtual object. The print instructions (or object generation instructions) may, in use thereof, control the additive manufacturing apparatus 500 to generate each of a plurality of layers of the object. This may for example comprise specifying area coverage(s) for print agents such as fusing agents, colorants, detailing agents and the like. In some examples, object generation parameters are associated with object model sub-volumes (voxels or pixels). In some examples, the print instructions comprise a print agent amount associated with sub-volumes. In some examples, other parameters, such as any, or any combination of heating temperatures, build material choices, an intent of the print mode, and the like, may be specified. In some examples, halftoning may be applied to determine where to place fusing agent or the like.

The additive manufacturing apparatus 500, in use thereof, generates object(s) in a plurality of layers (which may correspond to respective slices of an object model) according to the print instructions. The additive manufacturing apparatus 500 may for example generate object(s) in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. The additive manufacturing apparatus 500 may comprise additional components not shown herein, for example any or any combination of a fabrication chamber, a print bed, printhead(s) for distributing print agents, a build material distribution system for providing layers of build material, energy sources such as heat lamps and the like.

In some examples, object generation may comprise a fusing process, for example a thermal fusing process in which heat is applied.

The processing circuitry 402, 502 or the modules thereof may carry out any of the blocks of FIG. 1 or FIG. 2, or blocks 302 or 304 of FIG. 3.

FIG. 6 shows a tangible machine-readable medium 600 associated with a processor 602. The machine-readable medium 600 comprises instructions 604 which, when executed by the processor 602, cause the processor 602 to carry out tasks. In this example, the instructions 604 comprise instructions 606 to cause the processor 502 to update a 3D printing geometrical compensation model with a correction determined using a combination of a dimensional correction determined from measurements of objects generated using a first geometrical compensation and a dimensional correction determined from measurements of objects generated using a modified version of the first geometrical compensation.

The geometrical compensation models may comprise at least one scaling factor and at least one offset value, where in each of the scaling factors and each of the offset values may be associated with one of three orthogonal axes. The modified version of the first geometrical compensation may be a first generation modification, or a later generation modified version. The combination may be a difference in the effect, and may include consideration of scaling and/or offset(s).

In some examples, the instructions 604 comprise instructions which when executed cause the processor 602 to determine indications of deviations of printed object measurements from expected measurements; and derive compensation values based on a linear regression wherein the compensation values correct the measurements to match the corresponding expected measurement.

In some examples, the instructions when executed cause the processor 602 to carry out any of the blocks of FIG. 1 or FIG. 2, or blocks 302 or 304 of FIG. 3. In some examples, the instructions may cause the processor 602 to act as any part of the processing circuitry 402, 502 of FIG. 4 or FIG. 5.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus functional modules of the apparatus (such as the correction module 404, the model modification module 504 and/or the print instructions module 506) may be implemented by a processor executing machine-readable instructions stored in a memory (e.g. the machine readable medium 600), or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims. Based on means based at least in part on.

The features of any dependent claim may be combined with the features of any of the independent claims or other dependent claims.

What is claimed is:

1. A method comprising:
receiving, at a processor, at least one of a first and a second geometrical compensation to compensate for anticipated deformations in additive manufacturing; and
determining a third geometrical compensation based on a combination of
(i) a first compensation correction for a first build operation which utilised the first geometrical compensation to generate a first set of objects, and
(ii) a second compensation correction for a second build operation which utilised the second geometrical compensation to generate a second set of objects,
wherein:
the first compensation correction was derived to correct for deviations between the dimensions of the first set of objects and their intended dimensions;
the second compensation correction was derived to correct for deviations between the dimensions of the second set of objects and their intended dimensions; and
the second geometrical compensation is a modified version of the first geometrical compensation.

2. A method according to claim 1 wherein the third geometrical compensation is determined based on the first geometrical compensation and a combination of the first geometrical compensation correction and the second compensation correction.

3. A method according to claim 1 wherein the third geometrical compensation is determined based on the second geometrical compensation and a combination of the first geometrical compensation correction and the second compensation correction.

4. A method according to claim 1 wherein the first set of objects and the second set of objects are based on the same underlying object model data and wherein the objects of each of the first set of objects and second set of objects are generated at dispersed locations within the fabrication chamber.

5. A method according to claim 1 in which the compensation values relate to one of three orthogonal axes, and the method is further carried out for two additional orthogonal axes.

6. A method according to claim 1 comprising:
determining at least one of the first and second compensation corrections by:
obtaining a plurality of measurements of the corresponding set of objects;
comparing the measurements to expected measurements to derive a set of indication of measurement deviations; and
deriving at least one compensation correction from the deviations.

7. A method according to claim 1, wherein the first, second and third geometrical compensations are geometrical compensation models which provide geometrical compensations which are associated with the location of an object within an additive manufacturing fabrication chamber.

8. A method according to claim 1 further comprising using the third compensation to modify object model data for use in a third build operation.

9. A method according to claim 8 further comprising:
determining object generation instructions based on the modified object model data; and
generating at least one object based on the object generation instructions.

10. Apparatus comprising processing circuitry, the processing circuitry comprising:
a compensation correction module to update a geometrical compensation parameter with a correction parameter determined using a combination of a dimensional correction determined from measurements of objects generated using a first geometrical compensation and a dimensional correction determined from measurements of objects generated using a modified version of the first geometrical compensation.

11. Apparatus according to claim 10 further comprising a model modification module to modify a virtual object representing a first object to be generated using additive manufacturing using the updated geometrical compensation.

12. Apparatus according to claim 11 further comprising:
a print instructions module to determine print instructions for generating the first object from data representing the modified virtual object.

13. Apparatus according to claim 12 further comprising additive manufacturing apparatus to generate an object according to the print instructions.

14. A machine-readable medium storing instructions which, when executed by a processor, cause the processor to:
update a 3D printing geometrical compensation model with at least one correction determined using a combination of a dimensional correction determined from measurements of objects generated using a first geometrical compensation and a dimensional correction determined from measurements of objects generated using a modified version of the first geometrical compensation.

15. Machine readable medium according to claim 14 further comprising instructions which, when executed by a processor cause the processor to:
determine indications of deviations of printed object measurements from expected measurements; and
derive compensation values based on a linear regression wherein the compensation values correct the measurements to match the corresponding expected measurement.
